(19) United States
(12) Patent Application Publication
(10) Pub. No.: US 2025/0169635 A1
(43) Pub. Date: May 29, 2025

(54) Bag Hook

(71) Applicant: Illinois Tool Works Inc., Glenview, IL (US)

(72) Inventor: Ivan Martin Mariño, Sabadell (ES)

(21) Appl. No.: 18/948,125

(22) Filed: Nov. 14, 2024

(30) Foreign Application Priority Data
Nov. 27, 2023 (EP) 23212410.7
Nov. 8, 2024 (DE) 10 2024 132 738.3

(51) Int. Cl. A47G 29/08; B60R 7/08

(52) U.S. Cl. CPC A47G 29/08; B60R 7/08

(57) ABSTRACT

Disclosed is a bag hook that is suitable for third-party fixing-free attachment to a plate structure. The bag hook includes a hook member and a boss connected to the hook member. The boss comprises at least one locating lip and at least one resilient tongue.

### RELATED APPLICATIONS

The present application claims the benefit of European Patent Application No. EP 23212410.7, filed Nov. 27, 2023, and German Patent Application No. DE 10 2024 132 738.3, filed Nov. 8, 2024, each titled “Bag Hook,” the contents of which are hereby incorporated by reference.

### TECHNICAL FIELD

The disclosure relates to bag hooks. In particular, the disclosure relates to a bag hook which does not require a third-party fixing and easy attachment.

### BACKGROUND

Bag hooks are provided in vehicles for users convenience and utility. The location of these within the vehicle needs to be pre-planned carefully and their addition accounted for early in the design of a vehicle.

Bag hooks often require a threaded back nut or other fastener to be pre-provided at designated locations in the vehicle body-in-white to allow the bag hook to be fastened to the body in white with a complementary fixation, such as a threaded bolt or screw. The fastening provided in the body needs to be suitably formed or attached, such as via welding. This is time consuming, thereby increasing cost and manufacturing complexity. Likewise, the attachment of the bag hook using a third party fixing (threaded bolt, screw, or the like) increases complexity in requiring an operative to reach for the appropriate tool to make the attachment as well as cost in the provision of the third party fixation.

Such a system also prevent retro-fixation of additional bag hooks as the requisite fixing may not be pre-located on the body in white where a user wishes to retrofit a bag hook.

Service and replaceability of the bag hook is also a consideration, as such bag hooks can be prone to breakage or being caught and snapped. A third party fixation may not be intuitive to use, awkward, or require a specific tool to operate. This hampers an end user from performing a minor service or repair themselves.

### SUMMARY OF THE DISCLOSURE

The present disclosure relates generally to a bag hook, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates an example embodiment of a stowed bag hook connected to a suitable plate structure (e.g. a car chassis).

FIG. 2 illustrates an example embodiment of a stowed bag hook connected to a suitable plate structure (e.g. a car chassis) and entrapping a cover plate.

FIG. 3 illustrates, in partial transparency (cover plate), of the alternative positions of the bag hook, that is (a) stowed, and (b) deployed.

FIG. 4 illustrates, in partial transparency (cover plate), of the fitting process of a bag hook to a suitable substrate, including (a) & (b) associating the bag hook and cover plate with the substrate, (c) inserting a tab into a first aperture and rotating the bag hook about the tab, and (d) urging a resilient member through a second aperture to lock the bag hook into place on the substrate.

### DETAILED DESCRIPTION

Certain terminology is used in the following description for convenience only and is not limiting. The words ‘right’, ‘left’, ‘lower’, ‘upper’, ‘front’, ‘rear’, ‘upward’, ‘down’ and ‘downward’ designate directions in the drawings to which reference is made and are with respect to the described component when assembled and mounted. The words ‘inner’, ‘inwardly’, ‘outer’ and ‘outwardly’ refer to directions toward and away from, respectively, a designated centreline or a geometric centre of an element being described (e.g. central axis), the particular meaning being readily apparent from the context of the description.

Further, as used herein, the terms ‘connected’, ‘attached’, ‘coupled’ and ‘mounted’ are intended to include direct connections between two members without any other members interposed therebetween, as well as, indirect connections between members in which one or more other members are interposed therebetween. The terminology includes the words specifically mentioned above, derivatives thereof, and words of similar import.

Further, unless otherwise specified, the use of ordinal adjectives, such as, “first”, “second” and “third” etc. merely indicate that different instances of like objects are being referred to and are not intended to imply that the objects so described must be in a given sequence, either temporally, spatially, in ranking or in any other manner.

Like reference numerals are used to depict like features throughout.

The illustrated example embodiment(s) relates to bag hooks, and in particular to bag hooks that are installed to a structure, such as, for example, a chassis of a vehicle, via a concealed fastener, thus, providing improved ease of use during installation.

According to a first example of the disclosure there is provided a bag hook, suitable for third-party fixing-free attachment to a plate structure. The bag hook comprises: a hook member and a boss connected to the hook member, wherein the boss comprises at least one locating lip and at least one resilient tongue. Advantageously, a secure fitment of the bag hook to the body in white may be achieved without any additional fixations. The bag hook may be removably attached to allow for easy service and replacement without tooling by an end user. The bag hook may be retrofitted to a body in white requiring only suitable apertures to be made to receive the locating lip and the resilient tongue. No welding of a fixation to an inaccessible interior of a frame is required.

Suitably the locating lip comprises a free end, and optionally wherein the free end curves away from the resilient tongue, in this way the free end can fit through a slot of a frame and act as a fulcrum about which the bag hook can rotate. The locating lip further serves as a secondary fixation relative to the resilient tongue thereby ensuring that the bag hook resists rotation in undesirable directions.

Preferably, the resilient tongue comprises a ramped surface adjacent a cliff face, the resilient tongue may provide a snap fit (reversible or permanent) within an aperture of the plate structure. The ramped surface allows for easy insertion into the aperture and the cliff face provides a trap from which the bag hook cannot then unintentionally escape from the aperture.

Appositely, the hook member is movable relative to the boss, and optionally wherein the hook member is movable between a stowed position and a deployed position. This allows the hook member to be repositioned by an end user into a desired position, or even stowed away then not in use.

Appropriately, the bag hook further comprises a cover plate, and optionally wherein the cover plate is arranged to obscure the boss from the view of an end user. In this way a pleasing finish to the bag hook may be provided, and the plate structure obscured by the cover plate in the case of retrofitting.

Suitably, the boss is formed of a single piece of material thereby simplifying manufacture of the bag hook.

Preferably, the boss is formed of a metal and optionally by stamping. A metal ensures that the bag hook is capable of bearing a design weight, and formation by stamping ensures a simple construction process.

Appositely, the at least one locating lip and the at least one resilient tongue are arranged to cooperate together in order to fix the bag hook to a plate structure. The locating lip, when placed in the slot, is spaced from the resilient tongue in order to align the resilient tongue with the aperture, ensuring easy fitment of the bag hook to the plate structure.

Appropriately, the at least one locating lip is curved to grip a far surface of a plate-structure via a slot in the plate structure. This ensures that the locating lip has a secure grip of the plate structure thereby preventing return of the locating lip through the slot.

Suitably, the at least one resilient tongue is sized to provide a snap fit within an aperture of the plate structure. The resilient tongue may be formed of a resilient strip that may reversibly deform, so as to fit through an aperture of dimensions which are less than that described by the resting shape adopted by the resilient tongue, and then snap back to that resting shape.

Preferably, the bag hook is reversibly attachable to a plate structure in order to allow for replacement or service of the bag hook.

Appropriately, in order to attach the bag hook to a plate structure, location in a slot of a plate structure of the at least one locating lip is required prior to insertion of the at least one resilient tongue into an aperture of the plate structure. This ensures that the resilient tongue is appropriately aligned with the aperture in the plate structure, as well as providing a fulcrum about which the bag hook may be rotated, thereby facilitating installation by hand, without additional tools.

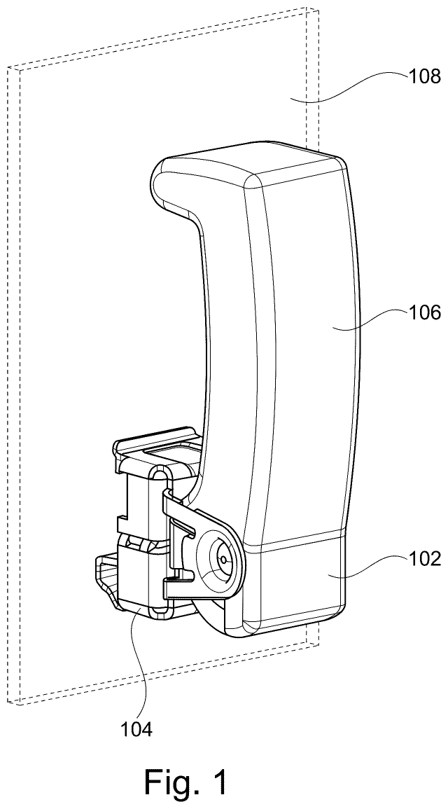

FIG. 1 shows a bag hook 102 connected to a substrate (such as the body in white of a chassis), absent a cover plate 202. The design is ready to assemble with no additional fixings or tools required. The bag hook 102 simply clips into two apertures (named as slot 404 and aperture 402 to avoid confusion herein) provided on the chassis, intuitively. No tools are needed to perform the assembly, which is performed by hand by urging the bag hook 102 into the apertures. This process is reversible too, thereby allowing the bag hook 102 to be easily removed.

No weld nut or other coupling is required on the chassis in order to fit the bag hook 102, only a pair of apertures. The bag hook 102 is “fixingless”, no additional fixing, such as a screw or bolt is required to attach the bag hook 102. This therefore saves on assembly time.

The omission of an extra fixing or coupling on the chassis results in a weight reduction compared to known bag hooks.

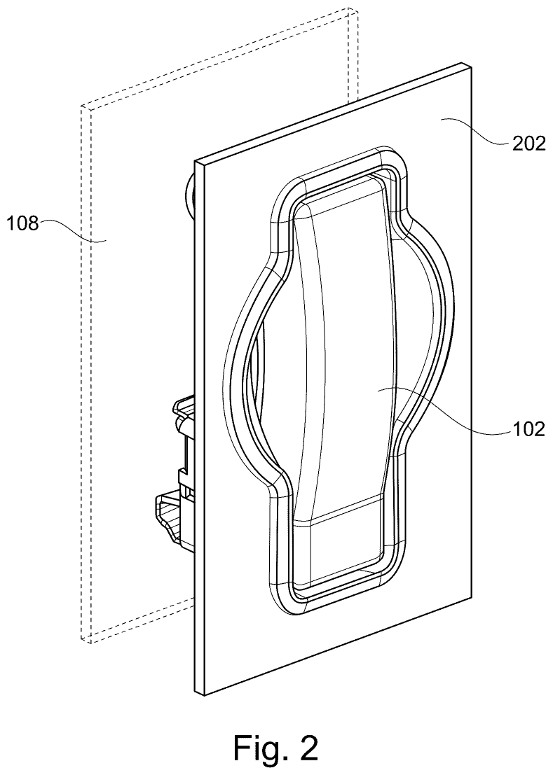

FIG. 2 shows the bag hook 102 of FIG. 1 connected to the substrate (known as a plate structure 108) with a cover plate 202. The cover plate 202 provides a housing for the bag hook 102 to be located when arranged in the stowed position and provides a high-quality finish on the interior of the vehicle.

The cover plate 202 is arranged to be trapped between the bag hook 102 and the plate structure 108 when the bag hook 102 is attached to the plate structure 108, and without any additional fixings. The bag hook 102 can be used with/without the cover plate 202. The cover plate 202 may comprise a recess for the bag hook 102 to sit within when placed in a stowed position, the bag hook 102 in the stowed position may be substantially flush with the cover plate 202. The bag hook 102 may be biased towards either the stowed position or the deployed position via e.g. A spring or the like is located within the boss and bearing upon the hook member 106.

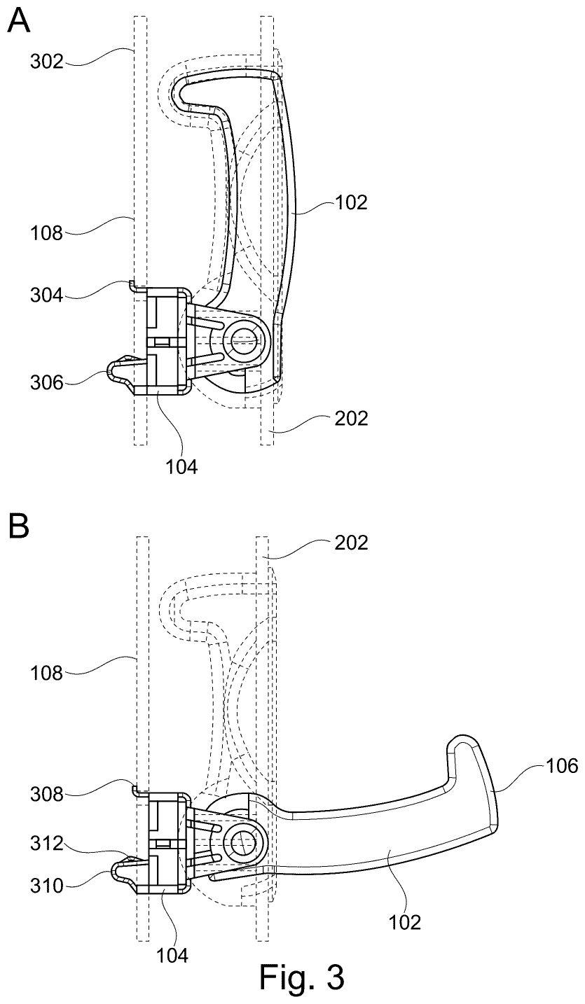

FIG. 3 shows the bag hook 102 of FIG. 1 and FIG. 2 in (a) a stowed position and located within the cover plate 202 (showed as transparent) and (b) in a deployed position ready to accept a load placed upon the hook, such as a bag or coat.

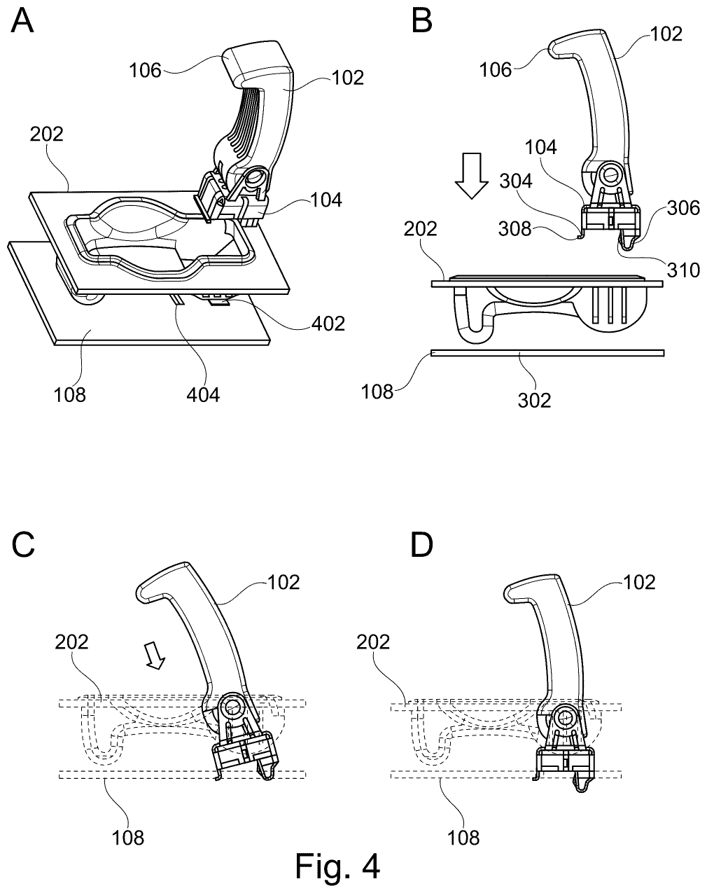

FIG. 4 shows a process of attaching the bag hook of FIG. 1, FIG. 2 and FIG. 3, as well as a cover plate (the same as previously shown) to plate structure 108. FIGS. 4(a) and (b) show how the parts are associated with one another prior to attachment with the cover plate sandwiched between the substrate and the bag hook. A slot 404 for the locating lip 304 and an aperture 402 for the resilient tongue 306 is provided on the plate structure 108 to accept corresponding features of the bag hook. FIG. 4(c) shows the partial insertion of the bag hook into the plate structure 108. A locating lip 304 is located in the slot 404, and thereby provides a fulcrum about which the bag hook may rotate to allow location of the resilient tongue 306 on the bag hook, into the aperture 402 on the substrate, to provide a snap fit. FIG. 4(d) shows the bag hook and cover plate (in transparency) located on the plate structure 108 with the locating lip 304 and resilient tongue 306 in the corresponding slot 404 and aperture 402 of the plate structure 108 and with the hook member 106 in a deployed position. Disassembly may be performed by reversing the assembly process. Alternatively, assembly may be one way. Ideally the assembly/disassembly is a tool-less process.

It will be appreciated by persons skilled in the art that the above detailed examples have been described by way of example only and not in any limitative sense, and that various alterations and modifications are possible without departing from the scope of the disclosure as defined by the appended claims. Various modifications to the detailed examples described above are possible.

Through the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A bag hook (102), suitable for third-party fixing-free attachment to a plate structure (108), the bag hook comprising:
a hook member (106); and
a boss (104) connected to the hook member;
wherein the boss comprises at least one locating lip (304) and at least one resilient tongue (306).

2. The bag hook of claim 1, wherein the locating lip comprises a free end (308), and optionally wherein the free end curves away from the resilient tongue.

3. The bag hook of claim 1, wherein the resilient tongue comprises a ramped surface (310) adjacent a cliff face (312).

4. The bag hook of claim 1, wherein the hook member is movable relative to the boss, and optionally wherein the hook member is movable between a stowed position and a deployed position.

5. The bag hook of claim 1, wherein the bag hook further comprises a cover plate, (202) and optionally wherein the cover plate is arranged to obscure the boss from the view of an end user.

6. The bag hook of claim 1, wherein the boss is formed of a single piece of material.

7. The bag hook of claim 1, wherein the boss is formed of a metal and optionally by stamping.

8. The bag hook of claim 1, wherein the at least one locating lip and the at least one resilient tongue are arranged to cooperate together in order to fix the bag hook to a plate structure.

9. The bag hook of claim 1, wherein the lip is curved to grip a far surface (302) of a plate-structure via a slot (404) in the plate structure.

10. The bag hook of claim 1, wherein the at least one resilient tongue is sized to provide a snap fit within an aperture (402) of the plate structure.

11. The bag hook of claim 1, wherein the bag hook is reversibly attachable to a plate structure.

12. The bag hook of claim 1, wherein, in order to attach the bag hook to a plate structure, location in a slot of a plate structure of the at least one locating lip is required prior to insertion of the at least one resilient tongue into an aperture of the plate structure.
